(19) United States
(12) Patent Application Publication
(10) Pub. No.: US 2009/0029190 A1
(43) Pub. Date: Jan. 29, 2009

(54) PERPENDICULAR MAGNETIC RECORDING MEDIUM, PRODUCTION PROCESS THEREOF, AND PERPENDICULAR MAGNETIC RECORDING AND REPRODUCING APPARATUS

(75) Inventors: Masahiro Ohmori, Oyama-shi (JP); Hiroshi Ohta, Oyama-shi (JP); Tetsuya Osaka, Tokyo (JP); Toru Asahi, Tokyo (JP); Tokihiko Yokoshima, Tokyo (JP)

Correspondence Address: SUGHRUE MION, PLLC, 2100 PENNSYLVANIA AVENUE, N.W., SUITE 800, WASHINGTON, DC, 20037, US

(73) Assignees: Showa Denko K.K., Tokyo (JP); Waseda University, Tokyo (JP)

(21) Appl. No.: 12/240,585

(22) Filed: Sep. 29, 2008

Related U.S. Application Data
(62) Division of application No. 11/118,468, filed on May 2, 2005.
Application No. 11/118,468 is a continuation-in-part of application No. PCT/JP03/13929, filed on Oct. 30, 2003.
(60) Provisional application No. 60/426,398, filed on Nov. 15, 2002.

(30) Foreign Application Priority Data
Oct. 31, 2002 (JP) 2002-318811
Dec. 9, 2002 (JP) 2002-356273
Mar. 18, 2003 (JP) 2003-72996
Apr. 17, 2003 (JP) 2003-112735

(51) Int. Cl. G11B 5/66; B29C 35/08; B05D 5/12

(52) U.S. Cl. 428/831; 427/599; 427/130

(57) ABSTRACT

A process for producing a perpendicular magnetic recording medium comprises forming metallic nuclei or a seed layer on a non-magnetic substrate, and forming a soft magnetic under layer on the metallic nuclei or the seed layer by means of electroless plating. The soft magnetic under layer is formed while an external parallel magnetic field is applied to the non-magnetic substrate, and the substrate is rotated such that the substrate is maintained parallel to the parallel magnetic field.

### CROSS REFERENCE TO RELATED APPLICATION

This application is division of U.S. application Ser. No. 11/118,468 filed May 2, 2005, which is a continuation-in-part application of International Application No. PCT/JPO3/13929, filed October 30, 2003, which claims the benefit of U.S. Provisional Application No. 60/426,398, filed November 15, 2002.

### BACKGROUND OF THE INVENTION

1. Field of the Invention:

The present invention relates to a perpendicular magnetic recording medium, to a process for producing the recording medium, and to a perpendicular magnetic recording apparatus. More particularly, the present invention relates to a perpendicular magnetic recording medium including a magnetic layer in which easy-magnetization axes are oriented perpendicular to a substrate, the magnetic layer serving as a recording layer.

2. Description of the Prior Art

Magnetic recording media used in practice are of a longitudinal recording type, which employs a magnetic layer having easy-magnetization axes which are oriented parallel with respect to the surface of a substrate. However, in this type of magnetic recording medium, adjacent magnetic domains serving as signal sources are magnetized in opposite directions, and the thus-magnetized magnetic domains repulsively interact with each other, thereby weakening their magnetization. Therefore, when the recording density of the recording medium is increased, adverse effects attributed to such a phenomenon become apparent.

In order to attain higher recording density, magnetic grains constituting the magnetic domains must be micronized. However, when the magnetic grains are micronized, demagnetization caused by thermal disturbance attributed to volume reduction of the magnetic grains becomes considerable, and thermal stability is impaired.

In connection with a technique for avoiding the adverse effects associated with an increase in recording density, for example, there has been proposed a perpendicular magnetic recording medium including a magnetic layer in which easy-magnetization axes are oriented perpendicular to the surface of a substrate, the magnetic layer being formed of a magnetic material having a high magnetic anisotropy energy (Ku) . In this type of magnetic recording medium, adjacent magnetic domains that are magnetized in opposite directions are advantageously stabilized in terms of magnetostatic energy. The higher the recording density of the recording medium, the more remarkable this characteristic feature is.

In general, in order to record signals on a magnetic recording layer, magnetization of magnetic grains in magnetic domains of the magnetic recording layer must be saturated by means of the magnetic field that leaks from a magnetic head. As has been known, in order to completely attain such saturation magnetization in a longitudinal recording medium, desirably, the thickness of the magnetic recording layer of the medium is reduced to the greatest possible extent.

Meanwhile, in a perpendicular magnetic recording system, when a single-pole magnetic head and a lamination-type medium including a perpendicular magnetic recording layer and a soft magnetic layer of high saturated magnetic flux density which is provided below the recording layer are employed, the soft magnetic layer serving as an undercoat layer plays a role for strongly attracting the magnetic field which leaks from the magnetic head and for returning the magnetic field to the magnetic head, and therefore, even if the thickness of the magnetic recording layer is not reduced, magnetization of the magnetic recording layer is readily saturated.

The aforementioned soft magnetic layer is desirably a soft magnetic layer having high magnetic permeability and high, saturated, magnetic flux density. However, in general, magnetic domain walls are generated in such a soft magnetic layer, and thus the soft magnetic layer causes problems, including occurrence of spike noise attributed to motion or fluctuation of the domain walls, as well as instabilization of recording magnetization; for example, demagnetization and loss of recorded data attributed to motion of the domain walls caused by external floating magnetic field (see, for example, JP-A HEI 6-187628, 5-81662, 7-105501 and 7-220921; The Journal of Electroanalytical Chemistry, Vol. 491 (2000), p. 197-202; and Proceedings of 25th Academic Lecture Meeting of The Magnetics Society of Japan, 2001, 26aA-2).

Japanese Patent No. 2,911,050 discloses formation of stripe magnetic domains through plating and a method for fabricating a perpendicular magnetic layer. However, there has never been reported production, through electroless plating, of a thin layer having easy-magnetization axes oriented perpendicular to a substrate. In general, easy-magnetization axes tend to be formed in a direction parallel with respect to a substrate.

Notably, the term “undercoat layer” as used herein refers not to a layer which underlies a magnetic layer although this term generally refers to such an underlying layer, but to a layer which is generally called a “backing layer (layer).”

In order to solve the aforementioned problems, the present inventors have performed extensive studies, and have found that the aforementioned problems in relation to magnetic domain walls can be solved when metallic nuclei or a seed layer is formed on a non-magnetic substrate; a soft magnetic layer containing, for example, phosphorus (P) or boron (B) is formed on the metallic nuclei or seed layer by means of electroless plating; and the soft magnetic layer exhibits magnetic isotropy particularly in a longitudinal direction of the substrate or has easy-magnetization axes oriented perpendicular to the substrate. The present invention has been accomplished on the basis of this finding.

Thus, an object of the present invention is to provide a perpendicular magnetic recording medium, an undercoat layer of which generates no magnetic domain wall and attains low noise.

### SUMMARY OF THE INVENTION

The present invention provides a perpendicular magnetic recording medium comprising a non-magnetic substrate, and at least a soft magnetic under layer formed of a soft magnetic material, an alignment-regulating layer for regulating the crystal alignment of a layer provided directly thereon, a perpendicular magnetic layer in which easy-magnetization axes are oriented generally perpendicular to the substrate, and a protective layer, the layers and the layer being provided atop the substrate, wherein the soft magnetic under layer exhibits magnetic isotropy.

Preferably, the soft magnetic under layer exhibits magnetic isotropy in a longitudinal direction of the substrate.

Preferably, when the soft magnetic under layer is formed on the non-magnetic substrate of disk-like shape, the ratio between Hs (the minimum intensity of a magnetic field applied to the undercoat layer as obtained when saturated magnetic flux density is measured) in a tangential direction of the undercoat layer and Hs in a radial direction of the undercoat layer; i.e., the degree of isotropy, falls within a range of 1.0±0.2.

The soft magnetic under layer has a saturated magnetic flux density (Bs) falling within a range of 0.001 T to 1.7 T.

Preferably, the soft magnetic under layer has a saturated magnetic flux density (Bs) falling within a range of 0.01 T to 1.5 T.

Preferably, the soft magnetic under layer is formed of microcrystals having a crystal grain size of 5 nm or less or has an amorphous structure.

Preferably, the soft magnetic under layer has a thickness falling within a range of 50 nm to 5,000 nm.

The surface of the soft magnetic under layer on which a perpendicular magnetic recording layer is to be laminated may have an average surface roughness (Ra) of 0.8 nm or less.

The soft magnetic under layer may contain phosphorus or boron.

Preferably, the non-magnetic substrate is a silicon substrate.

The invention also provides a perpendicular magnetic recording medium comprising a non-magnetic substrate; and at least a soft magnetic under layer formed of a soft magnetic material, an alignment-regulating layer for regulating the crystal alignment of a layer provided directly thereon, a perpendicular magnetic layer in which easy-magnetization axes are oriented generally perpendicular to the substrate, and a protective layer, the layers and the layer being provided atop the substrate, wherein the soft magnetic under layer has easy-magnetization axes oriented perpendicular to the substrate.

Preferably, the soft magnetic under layer exhibits perpendicular magnetic anisotropy having an anisotropy field (Hk) falling within a range of 395 A/m to 3,950 A/m (5 Oe to 50 Oe).

The soft magnetic under layer has a saturated magnetic flux density (Bs) falling within a range of 0.001 T to 1.7 T.

Preferably, the soft magnetic under layer has a saturated magnetic flux density (Bs) falling within a range of 0.01 T to 1.5 T.

Preferably, the soft magnetic under layer has a thickness falling within a range of 50 nm to 5,000 nm.

The surface of the soft magnetic under layer on which a perpendicular magnetic recording layer is to be laminated may have an average surface roughness (Ra) of 0.8 nm or less.

The soft magnetic under layer may contain phosphorus or boron.

Preferably, the non-magnetic substrate is a silicon substrate.

The present invention provides a process for producing a perpendicular magnetic recording medium, comprising forming metallic nuclei or a seed layer on a non-magnetic substrate, and forming a soft magnetic under layer on the metallic nuclei or seed layer by means of electroless plating, wherein the soft magnetic under layer is formed while an external parallel magnetic field is applied to the non-magnetic substrate, and the substrate is rotated such that the substrate is maintained parallel to the parallel magnetic field.

The present invention also provides a perpendicular magnetic recording medium produced through the production process.

The present invention also provides a perpendicular magnetic recording and reproducing apparatus comprising a perpendicular magnetic recording medium as recited above, and a magnetic head for recording of data onto the medium and for reproduction of the data therefrom.

The present invention also provides a non-magnetic substrate having a soft magnetic under layer thereon, wherein the substrate assumes a disk-like shape, and the ratio between Hs (the minimum intensity of a magnetic field applied to the undercoat layer as obtained when saturated magnetic flux density is measured) in a tangential direction of the undercoat layer and Hs in a radial direction of the undercoat layer; i.e., the degree of isotropy, falls within a range of 1.0±0.2.

Preferably, the soft magnetic under layer has a saturated magnetic flux density (Bs) falling within a range of 0.2 T to 1.7 T.

The present invention also provides a non-magnetic substrate having a soft magnetic under layer thereon, wherein the substrate assumes a disk-like shape and has easy-magnetization axes oriented perpendicular to the substrate.

Preferably, the soft magnetic under layer exhibits perpendicular magnetic anisotropy having an anisotropy field (Hk) falling within a range of 395 A/m to 3,950 A/m (5 Oe to 50 Oe).

The present invention also provides a process for producing a non-magnetic substrate having a soft magnetic under layer thereon, including forming metallic nuclei or a seed layer on a non-magnetic substrate and forming a soft magnetic under layer on the metallic nuclei or the seed layer by means of electroless plating, wherein the process further comprises polishing a surface of the non-magnetic substrate before formation of the metallic nuclei or the seed layer or polishing a surface of the soft magnetic under layer after formation of the soft magnetic under layer.

The present invention also provides a process for producing a non-magnetic substrate having a soft magnetic under layer thereon, including forming metallic nuclei or a seed layer on a non-magnetic substrate and forming a soft magnetic under layer on the metallic nuclei or the seed layer by means of electroless plating, wherein the process further comprises polishing a surface of the non-magnetic substrate before formation of the metallic nuclei or the seed layer and polishing a surface of the soft magnetic under layer after formation of the soft magnetic under layer.

In the above processes, the non-magnetic substrate may be heat-treated at a temperature falling within a range of 100° C. to 350° C. before polishing a surface of the substrate.

According to the present invention, an undercoat layer having no magnetic domain wall can be formed. When the undercoat layer is employed, there can be provided a perpendicular magnetic recording medium and a perpendicular magnetic recording and reproducing apparatus which exhibit high thermal stability and excellent noise characteristics, and which attain high-density recording.

Various other objects, features, and many of the attendant advantages of the present invention will be readily appreciated as the same becomes better understood with reference to the following detailed description of the preferred embodiments when considered in connection with accompanying drawings.

### BRIEF DESCRIPTION OF THE DRAWING

FIG. 1A is a cross-sectional view showing a magnetic recording medium according to an embodiment of the present invention.

FIG. 1B is a cross-sectional view showing a magnetic recording medium according to another embodiment of the present invention.

FIG. 2 is a schematic view showing the magnetic characteristics of a soft magnetic under layer used for a perpendicular magnetic recording medium of the present invention.

FIG. 3 shows the procedure of VSM measurement of an undercoat layer employed in the present invention.

FIG. 4 is a schematic representation showing the state of application of an external magnetic field and motion of a substrate during the course of plating performed in the production process of the present invention.

FIG. 5 shows an exemplary plating apparatus employed in the present invention.

FIG. 6 is a graph showing an exemplary MH loop.

FIG. 7 is a graph showing another exemplary MH loop.

FIG. 8A illustrates the overall configuration of an example of the perpendicular magnetic recording and reproducing apparatus of the present invention.

FIG. 8B shows the magnetic head of the perpendicular magnetic recording and reproducing apparatus.

FIG. 9 is a graph showing the procedure of determining the perpendicular magnetic anisotropy (Hk) according to the present invention. The mark following “Hk” shown in the right section of the graph denotes “perpendicular.”

### DETAILED DESCRIPTION OF THE PREFERRED EMBODIMENTS

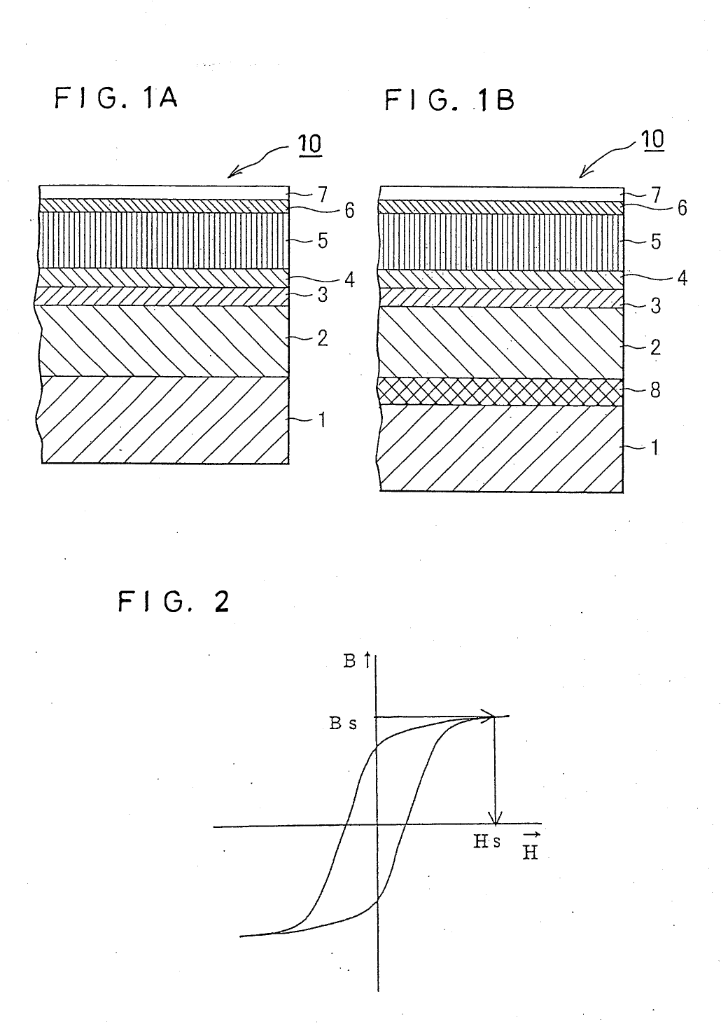

FIG. 1A shows one example of the magnetic recording medium of the present invention. The magnetic recording medium 10 comprises a soft magnetic under layer 2, an alignment-regulating layer 3, an intermediate layer 4, a perpendicular magnetic layer 5, a protective layer 6 and a lubricant layer 7 deposited in that order on a nonmagnetic substrate 1.

FIG. 1B shows another example of the magnetic recording medium 10 of the present invention, in which a permanent magnet layer 8 having magnetic anisotropy directed mainly to an in-plane direction is provided between the nonmagnetic substrate 1 and soft magnetic under layer 2 of the first example.

The soft magnetic under layer employed in the present invention is formed of, for example, a soft magnetic layer formed, by means of electroless plating, on metallic nuclei or a seed layer, the nuclei or layer being formed on a non-magnetic substrate, and the soft magnetic under layer exhibits magnetic isotropy.

The perpendicular magnetic recording medium of the present invention preferably has a soft magnetic under layer that exhibits magnetic isotropy in a longitudinal direction of the substrate.

More specifically, when the undercoat layer is formed on the substrate of disk-like shape, the ratio between Hs in a tangential direction of the undercoat layer and Hs in a radial direction of the undercoat layer; i.e., the degree of isotropy, preferably falls within a range of 1.0±0.2.

FIG. 2 schematically shows magnetic characteristics of the soft magnetic under layer employed in the present invention. Magnetic characteristics of the undercoat layer are measured by use of a VSM (vibrating sample magnetometer), and a hysteresis loop shown in FIG. 2 is obtained. Hs is calculated from the saturated magnetic flux density (Bs) obtained from the hysteresis loop.

In general, when a soft magnetic layer is formed by means of electroless plating, anisotropic magnetocrystalline alignment occurs in the layer, leading to generation of magnetic domain walls. Conventionally, such a soft magnetic layer has not been satisfactory for use as an undercoat layer for producing a perpendicular magnetic recording medium, since the magnetic layer causes generation of, for example, spike noise.

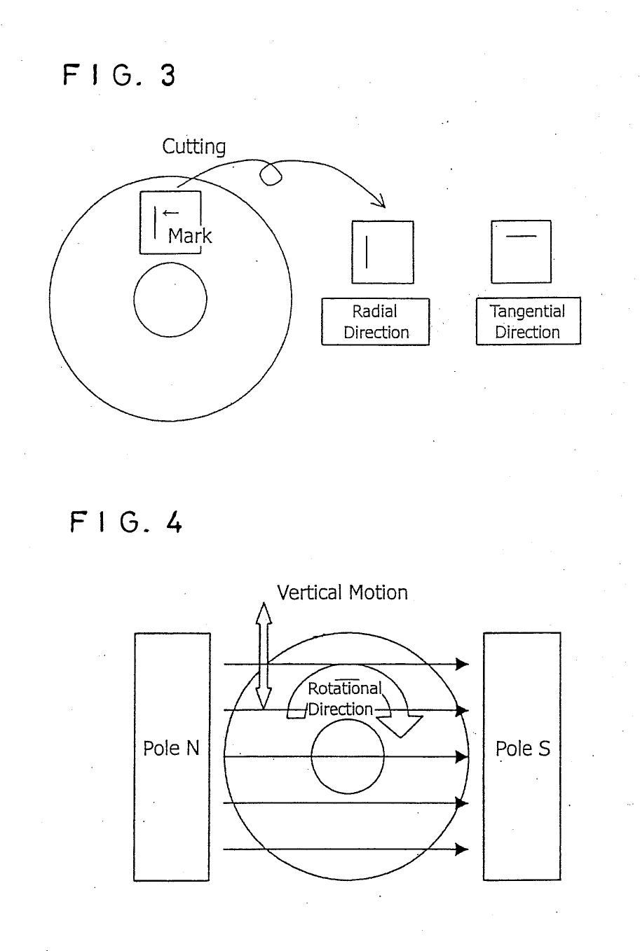

The present inventors have found that, when a soft magnetic layer is formed by means of electroless plating under application of an external parallel magnetic field, occurrence of anisotropic magnetocrystalline alignment of the soft magnetic layer can be prevented, and magnetic isotropy can be imparted to the layer, and thus have accomplished the present invention. The intensity of the applied magnetic field as measured when Bs is obtained through the VSM measurement is defined as “Hs” (see FIG. 2). Hs is an index for determining the direction in which magnetization readily occurs. When Hs is low in a direction of the soft magnetic under layer, the layer has easy-magnetization axes oriented in the direction. The ratio between Hs in a first direction of the soft magnetic layer and Hs in a second direction of the layer that is inclined at 90° to the first direction; i.e., the degree of isotropy, represents magnetic isotropy of the entirety of the layer. When the ratio is close to 1.0, the soft magnetic layer is considered to exhibit magnetic isotropy. A soft magnetic layer formed by means of a conventional electroless plating technique exhibits anisotropic magnetocrystalline alignment. Therefore, when the soft magnetic layer is subjected to the aforementioned VSM measurement, Bs in a radial direction of the layer becomes equal to Bs in a tangential direction thereof, but the intensity of the applied magnetic field required for obtaining the former Bs differs from that of the applied magnetic field required for obtaining the latter Bs. In view of the foregoing, as shown in FIG. 3, a test piece was cut out of the soft magnetic under layer formed on the non-magnetic substrate of disk-like shape such that the test piece includes the undercoat layer and the substrate, Hs in a tangential direction of the test piece and Hs in a radial direction thereof were obtained, and the degree of isotropy was determined by use of the following formula.

Degree of isotropy=Hs (in a tangential direction)/Hs (in a radial direction)

In general, in the vicinity of Bs, the rate of change in B is small even when the intensity of the applied magnetic field changes. Therefore, for the sake of convenience, as the value Hs, there may be employed an H value which is calculated from a B value obtained by multiplying Bs by a certain coefficient (e.g., 95%).

When a soft magnetic layer is formed by means of a conventional electroless plating technique, the resultant layer exhibits anisotropic magnetocrystalline alignment, and therefore Hs corresponding to Bs in a tangential direction of the layer differs from Hs corresponding to Bs in a radial direction of the layer. For example, when crystals of the layer are oriented in a tangential direction of the layer, since easy-magnetization axes are oriented in a tangential direction thereof, Hs (in a radial direction) becomes higher than Hs (in a tangential direction).

No particular limitation is imposed on the material of the substrate that can be employed in the present invention, any material can be employed so long as the material is non-magnetic and has a single-crystal, polycrystalline, or amorphous structure. Examples of the substrate include a glass wafer, a silicon wafer, and an aluminum disk. Of these, a silicon wafer and a glass wafer are particularly preferred. Needless to say, in the present invention, these substrates that have been in advance coated with a non-magnetic substance such as Ni-P may also be employed.

In the present invention, the soft magnetic layer containing, for example, P, which serves as the undercoat layer is formed by means of electroless plating. During the course of electroless plating, a critical point is that an external parallel magnetic field is applied in advance to the substrate in a direction parallel to the surface of the substrate, and the substrate is rotated such that the substrate is maintained parallel to the magnetic field. When electroless plating is performed under the conditions where the external magnetic field is applied in advance to the substrate along a radial direction of the substrate, the resultant soft magnetic layer exhibits magnetic isotropy. The angle between the substrate and the parallel magnetic field preferably falls within a range of ±20° or thereabouts. FIG. 4 schematically shows the plating process.

In the present invention, the intensity (magnetic flux density) of the external magnetic field employed for plating is preferably about 10 G to about 500 G (10,000 G=1 T), more preferably 25 G to 150 G, as measured in the vicinity of the center of the substrate. No particular limitations are imposed on the magnet which may be employed for attaining such a magnetic field intensity, and the magnet may be a permanent magnet such as a ferrite magnet, a neodymium-iron-boron magnet, or a samarium-cobalt magnet; or an electromagnet. In the present invention, the magnet is fixed, and the substrate is rotated. However, even when the substrate is fixed and the magnet is rotated, the same effects as those of the present invention are obtained. As shown in FIG. 4, the substrate may be reciprocated vertically under application of the parallel magnetic field.

The soft magnetic material containing, for example, P employed in the present invention is preferably Co-Ni-P, Co-Fe-P, Co-Ni-Fe-P, or a similar material. In the present invention, Co-Ni-Fe-B; i.e., a B-containing material, is also preferred.

Materials having a single metal composition, such as Ni-P, Ni-B, Co-P and Co-B, can also be used, provided that in order to give a soft magnetic property to the material in the case of Ni-P or Ni-B the amount of P or B has to be reduced and that heating processing is adopted after the plating process to give magnetism to the material.

Before the soft magnetic layer is formed on the substrate, in order to facilitate formation of the layer, a surface exhibiting catalytic activity against an electroless plating solution must be formed on the substrate. A surface exhibiting catalytic activity is formed by means of a conventional catalyzation process, or a process for forming metallic nuclei or a seed layer on the substrate. Such a surface formation process must be appropriately selected in accordance with the type of the substrate. However, no particular limitations are imposed on the surface formation method, so long as the method can form a surface that enables uniform initiation of electroless plating for forming the soft magnetic layer serving as the undercoat layer.

Before formation of the metallic nuclei or seed layer, a surface of the non-magnetic substrate is preferably polished. Alternatively, a surface of the formed soft magnetic under layer may be polished. The two polishing steps may be performed in combination. The non-magnetic substrate may be heated at a temperature falling within a range of 100° C. to 350° C. before polishing a surface of the substrate.

Examples of the catalyzation process include a conventional single-solution-type Pd catalyzation process, a conventional double-solution-type Pd catalyzation process, and a Pd catalyzation process employing substitution. Before such an activation process is performed, the substrate may be subjected to a known preliminary treatment such as phosphoric acid treatment or acid treatment, or to ashing treatment employing, for example, oxygen plasma. Examples of the aforementioned metallic nuclei include metallic nuclei such as Ni nuclei or Cu nuclei. Ni nuclei or Cu nuclei can be formed on the surface of the substrate by means of, for example, a method for depositing Ni or Cu directly on a Si wafer. The metallic nuclei preferably exhibit non-magnetic property.

In the case of formation of a seed layer, preferably, the seed layer is formed of a metal exhibiting activity against the below-described reducing agent contained in an electroless plating solution for forming the undercoat layer. The seed layer formed of, for example, Ni, Cu, or an alloy thereof preferably has a thickness of 5 to 100 nm, particularly preferably 10 to 50 nm. In the case where the seed crystal layer is formed, Zn is preferably added to the seed layer in order to enhance adhesion between the substrate and the seed layer.

Examples of the method for forming the seed layer include a dry method such as sputtering or vapor deposition and a wet method such as substitution plating or electroless plating. When the seed layer is formed by means of electroless plating, metallic nuclei must be formed before formation of the seed layer. In this case, the metallic nuclei are preferably formed by means of a conventional Pd activation process. Similar to the case of the above-described catalyzation process, before formation of the metallic nuclei, the substrate may be subjected to a known preliminary treatment such as phosphoric acid treatment or acid treatment, or to ashing treatment employing, for example, oxygen plasma.

In the case where the seed layer is formed, in order to enhance adhesion between the substrate and the seed layer, preferably, an adhesion layer containing Ti, Cr, or a similar metal is formed between the substrate and the seed layer by means of a known technique such as sputtering. In this case, the adhesion layer preferably has a thickness of 5 to 50 nm, particularly preferably 10 to 30 nm.

In the present invention, the electroless plating solution employed for forming the undercoat layer is, for example, a plating solution containing metal ion species such as a cobalt ion, a nickel ion, and an iron ion; a phosphorus-containing reducing agent such as hypophosphorous acid or sodium hypophosphite, or a boron-containing reducing agent such as dimethylamineborane; and an agent for forming a complex of the aforementioned metal ion species.

Examples of the supply source of the metal ion species include water-soluble cobalt salts, nickel salts, and iron salts, such as cobalt sulfate, nickel sulfate, and iron sulfate. The compositional proportions of the supply sources (the compositional proportions of cobalt, nickel, and iron), and the concentration of metallic salts contained in the plating solution are appropriately determined such that the resultant undercoat layer exhibits intended magnetic characteristics. The total concentration of the metallic salts is preferably 0.01 to 3.0 mol/dm³, particularly preferably 0.05 to 0.3 mol/dm³.

The concentration of the reducing agent is also appropriately determined. The concentration of the reducing agent contained in the plating solution is preferably 0.01 to 0.5 mol/dm³, particularly preferably 0.01 to 0.2 mol/dm³.

The complex-forming agent to be employed is a known agent for forming a complex of the aforementioned metal ion species; for example, a carboxylic acid salt such as sodium citrate or sodium tartrate, or an ammonium salt such as ammonium sulfate. The concentration of the complex-forming agent contained in the plating solution is preferably 0.05 mol/dm³ or more, more preferably 0.1 to 1.0 mol/dm³. The plating solution preferably contains a crystal-regulating agent such as phosphorous acid. The concentration of the crystal-regulating agent is particularly preferably 0.01 mol/dm³ or more.

The plating solution may contain a pH buffer such as boric acid. The plating solution may also contain a surfactant, in order to enhance uniformity of the layer formed through electroless plating. The surfactant is preferably sodium dodecyl sulfate or polyethylene glycol. The plating solution may further contain a conventional additive such as a sulfur-containing additive, in order to enhance smoothness of the layer.

The temperature and pH of the plating solution are appropriately determined in accordance with the composition of the solution. The temperature of the plating solution is preferably 50° C. or higher, particularly preferably 70° C. to 95° C.; and the pH of the solution is preferably 8 or more, particularly preferably 9 or thereabouts. The undercoat layer formed by use of the electroless plating solution may be subjected to thermal treatment, in order to enhance its soft magnetic characteristics. In this case, the thermal treatment temperature is preferably 150 to 300° C.

The undercoat layer employed in the present invention preferably has an isotropy degree falling within a range of 1.0±0.2, more preferably 1.0±0.15. The saturated magnetic flux density (Bs) of the layer is preferably 0.001 T to 1.7 T inclusive, more preferably 0.01 T to 1.5 T inclusive. The thickness (t) of the layer is preferably 50 nm to 5,000 nm inclusive, more preferably 100 nm to 3,000 nm inclusive, and most preferably 200 nm to 3,000 nm.

The undercoating layer formed in accordance with the present invention may have easy-magnetization axes oriented perpendicular to the substrate. Such easy-magnetization axes oriented perpendicularly to the substrate are remarkably effective for preventing formation of magnetic domain walls. In this case, the anisotropy field (Hk) of easy-magnetization axes oriented perpendicular to the substrate; i.e., perpendicular magnetic anisotropy, is preferably 5 to 50 Oe, more preferably 10 to 30 Oe. Notably, 1 Oe is equivalent to about 79 A/m.

The soft magnetic under layer is preferably formed of microcrystals having a crystal grain size of 5 nm or less or has an amorphous structure.

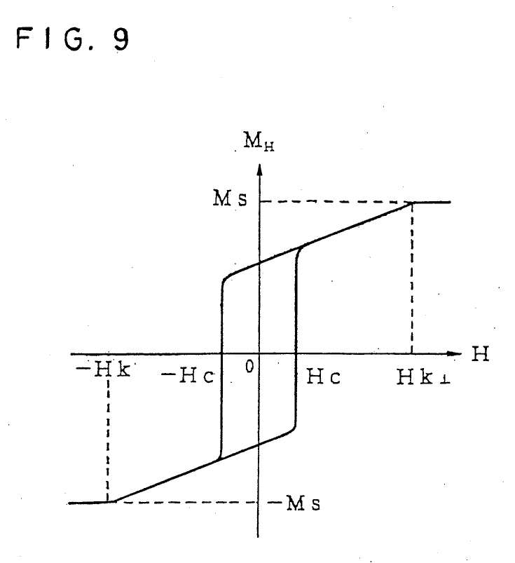

When perpendicular magnetic anisotropy is identified, as mention above, the anisotropy field (Hk) corresponds to a magnetic field value calculated from the Bs obtained from the hysteresis loop recorded by use of a VSM (see FIG. 9).

As described above, when magnetic isotropy is imparted to the undercoat layer, generation of magnetic domain walls is prevented, and the resultant perpendicular magnetic recording medium exhibits low noise and high performance, as well as enhanced S/N ratio and overwrite characteristics. No particular limitations are imposed on the coercive force (Hc) of the soft magnetic layer serving as the undercoat layer, but the coercive force is preferably 40 Oe or less (1 Oe=about 79 A/m), more preferably 10 Oe or less.

When, for example, the substrate having the undercoat layer is further subjected to surface smoothing by means of a generally employed technique, and a perpendicular magnetic recording layer is formed, a perpendicular magnetic recording medium of high performance can be produced. An example of such a magnetic recording medium will next be described.

No particular limitations are imposed on the composition of the perpendicular magnetic layer of the present invention, so long as easy-magnetization axes of the magnetic layer are oriented generally perpendicular to the substrate. Typically, a Co-based alloy material (for example, CoCrPt, CoCrPtB, CoCrPt-SiO₂, Co/Pd multi-layer, CoB/PdB multi-layer, CoSiO₂/PdSiO₂ multi-layer) or a similar material is preferably employed.

The perpendicular magnetic layer may have a single-layer structure formed of the aforementioned Co- based alloy material, or a structure of two or more layers including a layer formed of the aforementioned Co-based alloy material and a layer formed of a material other than the Co-based alloy material.

The perpendicular magnetic layer preferably has a structure in which a layer formed of a Co-based alloy and a layer formed of a Pd-based alloy are laminated, or a composite-layer structure including a layer formed of an amorphous material such as TbFeCo and a layer formed of a CoCrPt-based alloy material.

The thickness of the perpendicular magnetic layer is preferably 3 to 60 nm, more preferably 5 to 40 nm. When the thickness of the perpendicular magnetic layer is below the above range, sufficient magnetic flux fails to be obtained, and reproduction output is lowered, whereas when the thickness of the perpendicular magnetic layer 5 exceeds the above range, magnetic grains in the magnetic layer become large, and recording and reproduction characteristics are impaired.

The coercive force (Hc) of the perpendicular magnetic layer is preferably 3,000 Oe or more. When the coercive force is less than 3,000 Oe, the resultant magnetic recording medium is not suitable for attaining high recording density, and exhibits poor thermal stability.

The ratio of residual magnetization (Mr) to saturation magnetization (Ms) of the perpendicular magnetic layer; i.e., Mr/Ms, is preferably 0.9 or more. When the ratio Mr/Ms is less than 0.9, the resultant magnetic recording medium exhibits poor thermal stability.

The nucleation field (-Hn) of the perpendicular magnetic layer is preferably 0 Oe to 2,500 Oe inclusive. When the nucleation field (-Hn) is less than 0 Oe, the resultant magnetic recording medium exhibits poor thermal stability.

The nucleation field (-Hn) will next be described.

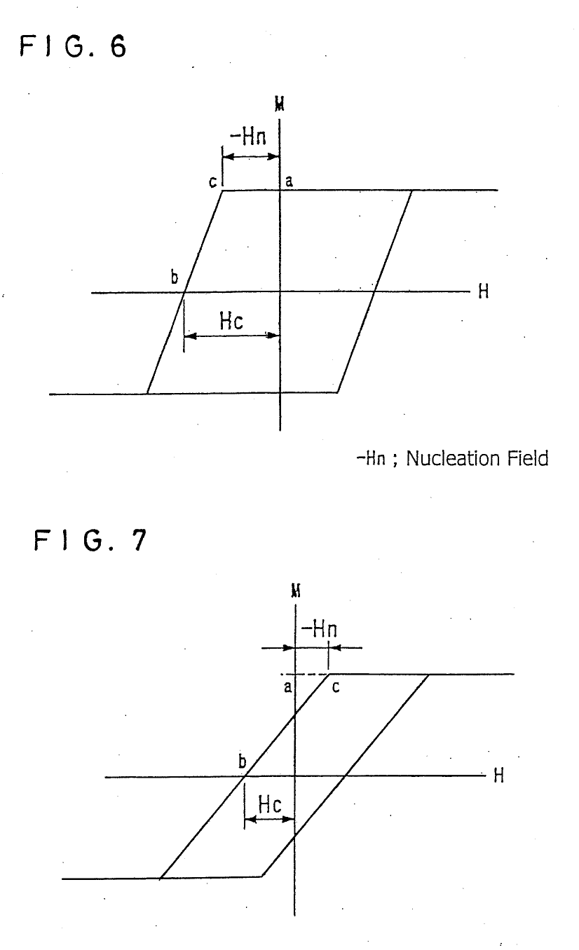

Specifically, the nucleation field (-Hn) is explained by use of an MH loop shown in FIG. 6. When a point a represents the point at which external magnetic field becomes zero when the external magnetic field is reduced after magnetization is saturated, a point b represents the point at which magnetization becomes zero, and a point c represents the point at which a line tangent to the MH loop at the point b intersects with a saturation magnetization line, the nucleation field (-Hn) can be represented by the distance (Oe) between the point a and the point c.

When the point c is located within the region in which the external magnetic field is negative, the nucleation field (-Hn) becomes positive (see FIG. 6). In contrast, when the point c is located within the region in which the external magnetic field is positive, the nucleation field (-Hn) becomes negative (see FIG. 7).

In the magnetic recording medium of the present invention, the alignment-regulating layer is formed of a non-magnetic material containing Ni in an amount of 33 to 80 at %, and one or more elements selected from among Sc, Y, Ti, Zr, Hf, Nb, and Ta. Therefore, the magnetic recording medium exhibits excellent error rate characteristics and thermal stability.

When the magnetic recording medium of the present invention, which includes the undercoat layer, is combined with a conventional complex-type recording head, a magnetic recording apparatus can be produced. In this case, preferably, the complex-type recording head can generate a recording magnetic field of 3.0 kOe or more.

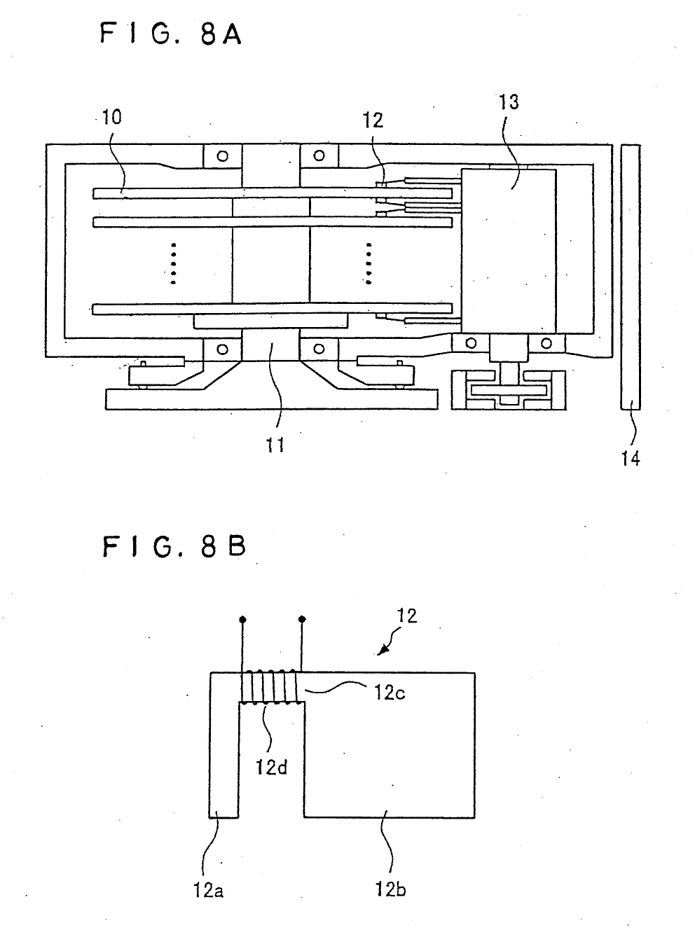

FIG. 8A schematically shows a perpendicular magnetic recording and reproducing apparatus incorporating the perpendicular magnetic recording medium of the present invention. FIG. 8B shows the magnetic head of the perpendicular magnetic recording and reproducing apparatus. The magnetic recording and reproducing apparatus is equipped with a magnetic recording medium 10 having a configuration shown in FIG. 1A or FIG. 1B, a medium drive section 11 that rotates the magnetic recording medium 10, a magnetic head 12 that records information on the magnetic recording medium 10 and reproduces the recorded information, a head drive section that moves the magnetic head 12 relative to the magnetic recording medium 10, and a recording and reproducing signal processing system 14. The recording and reproducing signal processing system 14 is adapted to process data input from the outside to transmit recorded signals to the magnetic head 12 and to process reproducing signals from the magnetic head 12 to transmit the processed data to the outside. As the magnetic head 12 used for the magnetic recording and reproducing apparatus of the present invention, a magnetic head that has as a reproducing element a GMR element utilizing a giant magnetic resistance (GMR) element and is suitable for high-density recording can be cited.

According to the aforementioned magnetic recording and reproducing apparatus, since the magnetic recording medium of the present invention is used as the magnetic recording medium 10, micronization of the magnetic particles and magnetic isolation are promoted to enhance a signal/noise (S/N) ratio to a great extent when reproduction is performed. In addition, the nucleation field (-Hn) can also be enhanced to enhance the thermal disturbance characteristics and obtain a medium having further excellent recording characteristics (OW). For this reason, it is made possible to provide an excellent magnetic recording and reproducing apparatus suitable for high-density recording.

The present invention will next be described in detail by way of Examples and Comparative Examples, which should not be construed as limiting the invention thereto.

### EXAMPLE 1

A glass substrate having an average surface roughness (Ra) of 0.5 nm or less was subjected to chemical cleaning, and subsequently, by means of DC magnetron sputtering, an adhesion layer constituted by a Ti layer (thickness: 10 nm) and a seed layer constituted by an Ni layer (thickness: 20 nm) were successively formed. Subsequently, the resultant layered product was subjected to a conventional preliminary treatment, and then a CoNiFeP soft magnetic layer (thickness: 3,000 nm) serving as an undercoat layer was formed by use of an electroless plating solution shown in Table 1.

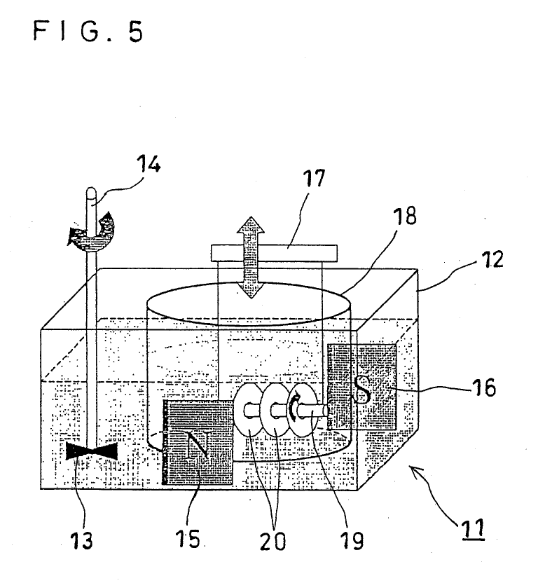

An example of the apparatus 11 for forming the soft magnetic layer is shown in FIG. 5. A plating bath 18 filled with a plating solution is placed in a water tank 12, and glass substrates 20 on which the seed layer has been formed and which are retained on a substrate retainer 19 equipped with a rotary mechanism (not shown) are immersed in the plating solution within the plating bath 18. The substrate retainer 19 is supported in a vertically movable fashion by a substrate-retaining jig 17. An N-pole magnet 15 and an S-pole magnet 16 are disposed across the plating bath 18 so that an external magnetic field can be applied along the radial direction of each glass substrate having the seed layer formed thereon. In order to keep the temperature of the water in the water tank 12 constant, a stirring rod 14 equipped at the lower end thereof with stirring wings 13 is provided inside the water tank 12.

The above apparatus was used, a magnetic flux having the intensity of 35 G was applied to the center of each glass substrate and the rotation speed of each glass substrate was regulated to 6.5 rpm to thereby form the soft magnetic layer on each glass substrate.

Subsequently, the thus-formed undercoat layer was subjected to chemical mechanical polishing by use of an abrasive fluid predominantly containing alumina and silica. Through this procedure, the average surface roughness (Ra) of the undercoat layer was regulated to 0.6 to 0.8 nm. After completion of polishing, the thickness of the undercoat layer was found to be 300 nm, and the saturated magnetic flux density (Bs) thereof was found to be 1.3 T. Hs in a tangential direction of the undercoat layer and Hs in a radial direction of the layer were measured by means of VSM measurement, and the degree of isotropy was obtained. As a result, the degree of isotropy was found to be 1.11. As mentioned above, perpendicular easy-magnetization axes were identified. The anisotropy field of perpendicular magnetic anisotropy was determined to be 10 Oe from a hysteresis loop. Furthermore, the undercoat layer was observed under an OSA (optical surface analyzer) for confirming the presence/absence of magnetic domain walls, and as a result, it was found that no magnetic domain wall was generated.

Subsequently, on the undercoat layer that had been dried under clean conditions, a Si layer (thickness: 5 nm) and a Pd layer (thickness: 5 nm) were formed at room temperature by means of DC magnetron sputtering, to thereby form an intermediate layer. The layered layer including the Si and Pd layers has a structure in which Si and Pd are partially interdiffused.

After completion of formation of the intermediate layer, 10 Co layers, each having a thickness of 0.2 nm, and 10 Pd layers, each having a thickness of 0.8 nm, were alternately laminated, to thereby form a perpendicular magnetic recording layer (thickness: 10 nm).

After completion of formation of the perpendicular magnetic recording layer, a C layer (thickness: 5 nm) serving as a protective layer was formed, to thereby produce a magnetic recording medium. Read-write conversion characteristics of the thus-produced magnetic recording medium were measured by use of a complex-type magnetic head including a single-pole head serving as a writing section and a shield-type magnetoresistive head serving as a reading section, whereby MF-S/N ratio was evaluated. Table 4 shows the evaluation results and the results of observation of magnetic domain walls.

### EXAMPLE 2

The procedure of Example 1 was repeated, except that the intensity of the external magnetic field applied during the course of plating was changed from 35 G to 100 G (neodymium-iron-boron magnets). Table 4 shows the results; i.e., Bs, the degree of isotropy, perpendicular magnetic anisotropy, MF-S/N ratio, and the presence/absence of magnetic domain walls.

### EXAMPLE 3

The procedure of Example 1 was repeated, except that the composition of the plating solution was changed as shown in Table 2. Table 4 shows the results; i.e., Bs, the degree of isotropy, perpendicular magnetic anisotropy, MF-S/N ratio, and the presence/absence of magnetic domain walls.

### EXAMPLE 4

The procedure of Example 1 was repeated, except that a plating solution containing the components shown in Table 1, exclusive of FeSO₄, was employed. Table 4 shows the results; i.e., Bs, the degree of isotropy, perpendicular magnetic anisotropy, MF-S/N ratio, and the presence/absence of magnetic domain walls.

### EXAMPLE 5

The procedure of Example 1 was repeated, except that the glass substrate employed in Example 1 was changed to a double-side polished silicon wafer substrate (1 inch) having an average surface roughness Ra of 0.3 nm or less. Table 4 shows the results; i.e., Bs, the degree of isotropy, perpendicular magnetic anisotropy, MF-S/N ratio, and the presence/absence of magnetic domain walls.

### EXAMPLE 6

The procedure of Example 1 was repeated, except that the composition of the plating solution was changed as shown in Table 3 (boron-containing plating solution). Table 4 shows the results; i.e., Bs, the degree of isotropy, perpendicular magnetic anisotropy, MF-S/N ratio, and the presence/absence of magnetic domain walls.

### EXAMPLE 7

In place of the glass plate used in Example 1, a 2.5-inch Al substrate was used. The substrate was subjected to both-surface polishing and activation treatment in the usual way. A NiP layer having a thickness of 12 um was plated as a seed layer on the substrate. The substrate was then heat-treated at 250° C. for 30 minutes to deprive the seed layer of distortion. The resultant seed layer was polished by about 2 μm using an abrasive fluid predominantly containing alumina-based abrasive material to have the average surface roughness Ra of 2 nm. Subsequently, An electroless plating bath was used under the same conditions as used in Example 1 to form as an undercoat layer a CoNiFeP soft magnetic layer having a thickness of 600 nm. The undercoat layer was heat-treated at 150° C. for 15 minutes and then polished by about 300 nm using an abrasive fluid predominantly containing silica to have the average surface roughness Ra of 0.1 to 0.3 nm. Subsequently, the same operation as used in Example 1 was performed. Shown in Table 4 are the Bs, degree of isotropy, perpendicular, anisotropic magnetic field, MF-S/N ratio and presence or absence of the magnetic domain walls of the undercoat layer.

### COMPARATIVE EXAMPLE 1

The procedure of Example 1 was repeated, except that an undercoat layer was formed by means of electroless plating without placing ferrite magnets; i.e., in the absence of an external parallel magnetic field, to thereby produce a perpendicular magnetic recording medium. The Bs and thickness of the undercoat layer was found to be 1.3 T and 300 nm, respectively. Through observation by use of an OSA, the undercoat layer was found to have magnetic domain walls.

### COMPARATIVE EXAMPLE 2

The procedure of Example 1 was repeated, except that a NiFe soft magnetic layer (thickness: 100 nm, saturated magnetic flux density (Bs): 1.0 T) serving as an undercoat layer was formed by means of sputtering, and the thus-formed layer was not subjected to smoothing treatment, to thereby produce a magnetic recording medium. Read-write conversion characteristics of the thus-produced magnetic recording medium were measured in a manner similar to that of Example 1, whereby S/N ratio was evaluated. The presence/absence of magnetic domain walls was confirmed through OSA measurement.

### COMPARATIVE EXAMPLE 3

The procedure of Comparative Example 2 was repeated, except that a soft magnetic layer was formed from CoNiFe in place of NiFe. The results are shown in Table 4.

As is clear from Table 4, the magnetic recording media of the Examples exhibit high MF-S/N ratio as compared with the magnetic recording media of the Comparative Examples, and magnetic domain walls are not generated in the magnetic recording media of the Examples. The reason why the magnetic recording medium of Example 1 exhibits particularly high S/N ratio is considered to be as follows. Since the soft magnetic layer of high Bs is employed as an undercoat layer, a large amount of the magnetic flux that leaks from the recording head is converged, leading to an increase in reproduction signals.

TABLE 1
Composition of plating solution

| | | |
|---|---|---|
| Hypophosphorous acid | 0.2 | mol/dm³ |
| C₃H₄(OH) (COONa)₃ | 0.1 | mol/dm³ |
| C₂H₂(OH)₂(COONa)₂ | 0.15 | mol/dm³ |
| (NH₄)₂SO₄ | 0.5 | mol/dm³ |
| FeSO₄•7H₂O | 0.002 | mol/dm³ |
| NiSO₄•6H₂O | 0.01 | mol/dm³ |
| CoSO₄•7H₂O | 0.04 | mol/dm³ |

| | |
|---|---|
| Temperature of the solution (° C.) | 90 |
| pH | 9 (adjusted by NaOH) |

TABLE 2
Composition of plating solution

| | | |
|---|---|---|
| Hypophosphorous acid | 0.2 | mol/dm³ |
| C₃H₄(OH) (COONa)₃ | 0.1 | mol/dm³ |
| C₂H₂(OH)₂(COONa)₂ | 0.15 | mol/dm³ |
| (NH₄)₂SO₄ | 0.5 | mol/dm³ |
| FeSO₄•7H₂O | 0.002 | mol/dm³ |
| NiSO₄•6H₂O | 0.025 | mol/dm³ |
| CoSO₄•7H₂O | 0.025 | mol/dm³ |

| | |
|---|---|
| Temperature of the solution (° C.) | 90 |
| pH | 9 (adjusted by NaOH) |

TABLE 3
Composition of plating solution

| | | |
|---|---|---|
| Dimethylaminborane (DMAB) | 0.025 | mol/dm³ |
| C₃H₄(OH) (COONa)₃ | 0.05 | mol/dm³ |
| C₂H₂(OH)₂(COONa)₂ | 0.20 | mol/dm³ |
| H₃PO₄ | 0.06 | mol/dm³ |
| (NH₄)₂SO₄ | 0.005 | mol/dm³ |
| FeSO₄•7H₂O | 0.01 | mol/dm³ |
| NiSO₄•6H₂O | 0.005 | mol/dm³ |
| CoSO₄•7H₂O | 0.095 | mol/dm³ |

| | |
|---|---|
| Temperature of the solution (° C.) | 70 |
| pH | 9 (adjusted by NaOH) |

TABLE 4

| | | | Anisotropic | | Magnetic |
|---|---|---|---|---|---|
| | | Degree of | magnetic | MF-S/N | domain |
| | Bs (T) | isotropy | field Hk (Oe) | ratio (dB) | walls |
| Ex. 1 | 1.3 | 1.11 | 10 | 12.5 | Absent |
| Ex. 2 | 1.3 | 0.97 | 15 | 13.4 | Absent |
| Ex. 3 | 0.5 | 1.05 | 8 | 10.9 | Absent |
| Ex. 4 | 1.2 | 0.89 | 20 | 11.7 | Absent |
| Ex. 5 | 1.3 | 1.11 | 25 | 12.5 | Absent |
| Ex. 6 | 1.5 | 1.03 | 10 | 14.5 | Absent |
| Ex. 7 | 1.5 | 1.11 | 10 | 12.5 | Absent |
| Comp. | 1.3 | 1.35 | No easy- | 8.3 | Present |
| Ex. 1 | | | magnetiza- | | |
| | | | tion axis | | |
| Comp. | 1.0 | 0.72 | No easy- | 9.5 | Present |
| Ex. 2 | | | magnetiza- | | |
| | | | tion axis | | |
| Comp. | 1.3 | 0.66 | No easy- | 7.1 | Present |
| Ex. 3 | | | magnetiza- | | |
| | | | tion axis | | |

### EXAMPLE 8

The procedure of Example 7 was repeated, except that a 400 nm-thick soft magnetic layer was formed (plating bath composition omitted) from CoNiP in place of the CoNiFeP soft magnetic layer having a thickness of 600 nm. Shown in Table 5 are the Bs, degree of isotropy, perpendicular magnetic anisotropy, MF-S/N ratio and presence or absence of the magnetic domain walls of the undercoat layer.

### EXAMPLE 9

The procedure of Example 7 was repeated, except that a 500 nm-thick soft magnetic layer was formed (plating bath composition omitted) from Co-B in place of the CoNiFeP soft magnetic layer having a thickness of 600 nm. Shown in Table 5 are the Bs, degree of isotropy, perpendicular magnetic anisotropy, MF-S/N ratio and presence or absence of the magnetic domain walls of the undercoat layer.

### EXAMPLE 10

The procedure of Example 7 was repeated, except that a 500 nm-thick soft magnetic layer was formed from NiP in place of the CoNiFeP soft magnetic layer having a thickness of 600 nm, provided that in order to attain a P content of 3% (at %) plating was performed using plating liquid having a composition of NiSo₄·6H₂O of 12 mol/dm³, (NH₄)SO₄ of 0.50 mol/dm³, C₃H₄(OH) (COONa)₃ of 0.12 mol/dm³ and hypo-phosphorous acid of 0.2 mol/dm³ at 70 C.°. Shown in Table 5 are the Bs, degree of isotropy, perpendicular magnetic anisotropy, MF-S/N ratio and presence or absence of the magnetic domain walls of the undercoat layer.

TABLE 5

| | | | Anisotropy | | Magnetic |
|---|---|---|---|---|---|
| | | Degree of | magnetic | MF-S/N | domain |
| | Bs (T) | isotropy | field Hk (Oe) | ratio (dB) | walls |
| Ex. 8 | 0.01 | 1.18 | No easy- | 12.2 | Absent |
| | | | magnetiza- | | |
| | | | tion axis | | |
| Ex. 9 | 1.3 | 0.97 | 35 | 13.4 | Absent |
| Ex. 10 | 0.002 | 1.05 | No easy- | 11.6 | Absent |
| | | | magnetiza- | | |
| | | | tion axis | | |

According to the present invention, an undercoat layer that has no magnetic domain walls can be formed. When the undercoat layer is employed, there can be provided a perpendicular magnetic recording medium and a perpendicular magnetic recording and reproducing apparatus which exhibit high thermal stability and excellent noise characteristics, and which attain high-density recording.

What is claimed is:

1. A process for producing a perpendicular magnetic recording medium, comprising forming metallic nuclei or a seed layer on a non-magnetic substrate, and forming a soft magnetic under layer on the metallic nuclei or the seed layer by means of electroless plating, wherein the soft magnetic under layer is formed while an external parallel magnetic field is applied to the non-magnetic substrate, and the substrate is rotated such that the substrate is maintained parallel to the parallel magnetic field.

2. A perpendicular magnetic recording medium produced through a production process as recited in claim 1.

3. A process for producing a non-magnetic substrate having a soft magnetic under layer thereon, including forming metallic nuclei or a seed layer on a nonmagnetic substrate and forming a soft magnetic under layer on the metallic nuclei or the seed layer by means of electroless plating, wherein the process further comprises polishing a surface of the non-magnetic substrate before formation of the metallic nuclei or the seed layer or polishing a surface of the soft magnetic under layer after formation of the soft magnetic under layer.

4. A process for producing a non-magnetic substrate having a soft magnetic under layer thereon as described in claim 3, wherein the process further comprises heat-treating the non-magnetic substrate at a temperature falling within a range of 100° C. to 350° C. before polishing a surface of the substrate.

5. A process for producing a non-magnetic substrate having a soft magnetic under layer thereon, including forming metallic nuclei or a seed layer on a nonmagnetic substrate and forming a soft magnetic under layer on the metallic nuclei or the seed layer by means of electroless plating, wherein the process further comprises polishing a surface of the non-magnetic substrate before formation of the metallic nuclei or the seed layer and polishing a surface of the soft magnetic under layer after formation of the soft magnetic under layer.

6. A process for producing a non-magnetic substrate having a soft magnetic under layer thereon as described in claim 5, wherein the process further comprises heat-treating the non-magnetic substrate at a temperature falling within a range of 100° C. to 350° C. before polishing a surface of the substrate.
